(19) United States
(12) Patent Application Publication
(10) Pub. No.: US 2022/0324530 A1
(43) Pub. Date: Oct. 13, 2022

(54) DRINKING VESSEL HOLDER

(71) Applicant: Graeme Hendry Green, Observatory (ZA)

(72) Inventor: Graeme Hendry Green, Observatory (ZA)

(21) Appl. No.: 17/630,175

(22) PCT Filed: Jul. 27, 2020
(86) PCT No.: PCT/IB2020/057071

§ 371 Date: Jan. 26, 2022

(30) Foreign Application Priority Data
Jul. 26, 2019 (GB) 1910710.1

(51) Int. Cl. B62J 11/04

(52) U.S. Cl. CPC B62J 11/04

(57) ABSTRACT

A holder for a vessel such as a water bottle is provided that includes a spine that is fixedly attachable to a substrate such as a bicycle frame, and a cradle that can hold the water bottle. The cradle can pivot relative to the spine, but is held in a centre position by a retention mechanism that preferably mechanism. The retention mechanism can include magnets disposed on the spine and cradle, as well as mechanical locking between a catch and a receiving formation.

### FIELD OF THE INVENTION

This invention relates to holders for holding drinking vessels such as water bottles. The invention is not necessarily restricted to applications relating to bicycling, but it is particularly suitable for holding water bottles on bicycles.

### BACKGROUND TO THE INVENTION

There is frequently a need to convey vessels containing liquids such as water or a beverage around, to enable a person to drink the liquid on demand. One of the most common types of containers or vessels used for this purpose is the so-called “water bottle” (although its use is not limited to water), which is typically a cylindrical vessel with a dispensing valve at its top.

Water bottles of this type are commonly used by cyclists who carry the bottles with them in holders on their bicycles, retrieve the bottles from the holders when needed, drink from the bottles and replace them in their holders. These steps are typically performed by the cyclist whilst continually cycling and it is preferable that a cyclist can retrieve and replace the water bottle easily, preferably without needing to look at the retrieving or replacing action. However, it is also essential that the water bottle be held securely in the holder.

By far the most common type of water bottle holder in use at present, is a so-called “bottle cage” which typically takes the form of a generally stiff frame that can extend partially around a water bottle to hold the water bottle tightly in place by combined resilience of the frame and bottle. The water bottles typically have a standard cylindrical shape and dimensions, with a diameter of 73 mm and a circumferential indentation or reduction in diameter, about 127 mm from the bottom of the bottle. The cage usually has a grip formation that engages the indentation in the water bottle.

The circumstances in which water bottles are required to be held in place on a bicycle, are quite demanding—often involving shocks and vibration. As a result, the engagement between cages and water bottles needs to be robust and to achieve this, cages are typically designed to extend around water bottles with an interference fit. However, the tight fit between cages and water bottles requires water bottles to be inserted with a precise orientation relative to the cage and the engagement needs to be made with sufficient force to overcome the interference between the cage and water bottle. The effort required to retrieve and return water bottles from and to bottle cages while cycling, often causes discomfort, disrupts cyclists' exercise rhythm and concentration, etc. with the results that cyclists perform sub-optimally or run a risk of falling, when retrieving or replacing water bottles.

Some non-standard water bottles and cages are available, but they still require an interference fit between the cage and water bottle, so that significant force and correct alignment of the water bottle is essential—with the disadvantages mentioned above.

Some water bottle holders have been developed that attach water bottles to bicycles with magnets, but the magnetic attachment is typically not strong enough to hold the bottles in place during rigorous activity, or need to be supplemented with additional attachment mechanisms, such as cumbersome bayonet-mechanisms. These developments also require non-standard water bottles or require attachment of magnetically attracted elements to the water bottles. Lastly, standard water bottles have sufficient axial symmetry to allow them to be inserted in cages with any rotational orientation about their longitudinal axes. However, to attach water bottles to bicycles by magnets, according to the prior art, the bottles need to be oriented about their axes with their attachment elements aligned with the complementary elements on the bicycle, so that the need to orientate the water bottles adds to the complexity, discomfort, disruption, and safety risks associated with retrieval and replacement of water bottles.

The difficulties in accessing and replacing water bottles while cycling are exacerbated when the bicycle configuration restricts the space within which a water bottle can be retrieved. This is particularly problematic with full-suspension mountain bikes where space between the top tube, seat tube and down tube is taken up by the suspension, so that there is inadequate space for fitting a water bottle cage and sliding the water bottle in and out of the cage. Some mountain bikers have resorted to fitting water bottle cages on the backs of their seat posts, but the same problem often surfaces, that the water bottle cannot be withdrawn longitudinally from the cage, because it is obstructed by the seat.

The present invention seeks to provide holders for drinking vessels, which can hold the drinking vessels securely, but which allow for easy and convenient retrieval of the drinking vessels from the holders and return of the drinking vessels to the holders. The drinking vessels may be standard water bottles and the holders may be cages for holding the water bottles on bicycles.

### SUMMARY OF THE INVENTION

According to the present invention there is provided a holder for a drinking vessel with a bottom part that has predetermined dimensions, the holder comprising:
a spine that is fixedly attachable to a substrate such as a bicycle frame;
a cradle that is shaped and dimensioned to receive the bottom part of the drinking vessel and to retain the bottom part of the drinking vessel in the cradle;
a pivot mechanism extending between the cradle and the spine, the pivot mechanism being configured to allow the cradle to pivot relative to the spine about a pivot axle, between a centre position and one or more tilted position; and
a retention mechanism that is disposed to retain the cradle in the centre position when the retention mechanism is engaged, and to allow the cradle to pivot to the tilted position when the retention mechanism is disengaged.

The retention mechanism may include one or more centre magnetic element that is disposed on the spine, and one or more cradle magnetic element that is disposed on the cradle, the centre and cradle magnetic elements being in close proximity to each other and being magnetically attracted to each other when the retention mechanism is engaged.

The term “magnetic element” includes different kind of magnets, as well as materials that are attracted to magnets.

The retention mechanism may include a mechanical lock that is configured to hold the cradle against pivotal movement relative to the spine, when the retention mechanism is engaged.

The mechanical lock may include a centre receiving formation that is defined on the spine in proximity to the centre magnetic element, and a movable catch that forms part of the cradle and that can engage the receiving formation to engage the mechanical lock retention mechanism, the cradle magnetic element being disposed on the catch such that magnetic attraction between the centre magnetic element and the cradle magnetic element causes the catch and cradle element to move towards the receiving formation and engage the receiving formation.

The pivot mechanism may be configured to allow the cradle to pivot about the pivot axis, between a centre position and two tilted positions on opposing sides of the centre position.

The holder may include one or more lateral magnet that is disposed to be attracted to either the centre magnetic element or the cradle magnetic element, when the cradle is in the tilted position.

### BRIEF DESCRIPTION OF THE DRAWINGS

For a better understanding of the present invention, and to show how it may be put into effect, the invention will now be described by way of non-limiting example, with reference to the accompanying drawings in which:

FIG. 1 shows a three-dimensional view of a first embodiment of a holder or cage for a drinking vessel or water bottle according to the present invention, in a closed condition;

FIG. 2 shows a side view of the holder of FIG. 1, in the closed condition;

FIG. 3 shows a three-dimensional view of the holder of FIG. 1 in an open condition;

FIG. 4 shows a side view of the holder of FIG. 1, in the open condition;

FIG. 5 shows a side view of the holder of FIG. 1, in the closed condition, with a water bottle held in the holder;

FIG. 6 shows a side view of the holder of FIG. 1, in the open condition, with a water bottle in the holder;

FIG. 7 shows a side view of the holder of FIG. 1, in the open condition, with a water bottle retrieved from the holder;

FIG. 8 shows a side view of the holder of FIG. 1, in the closed condition, rotated through an acute angle;

FIG. 9 shows a three-dimensional view of the holder of FIG. 1, in the closed condition, rotated through an acute angle;

FIG. 10 shows a side view of the holder of FIG. 1, in the closed condition, rotated through a right angle;

FIG. 11 shows a three-dimensional view of the holder of FIG. 1, viewed from an angle different from FIG. 9, in the closed condition, rotated through an acute angle;

FIG. 12 shows a three-dimensional view of the holder of FIG. 1, viewed from the same angle as FIG. 11, in the open condition, rotated through an acute angle;

FIG. 13 shows a three-dimensional view of a bicycle frame with the holder of FIG. 1 fitted on the bicycle frame, in the closed condition, holding a water bottle;

FIG. 14 shows a three-dimensional view of the bicycle frame of FIG. 13 with the holder in the open condition, with the water bottle in the holder;

FIG. 15 shows a three-dimensional view of the bicycle frame of FIG. 13 with the holder in the closed condition, rotated through a right angle, holding the water bottle;

FIG. 16 shows a three-dimensional view of the bicycle frame of FIG. 13 with the holder in the open condition, rotated through a right angle, with the water bottle in the holder; and

FIG. 17 shows an exploded oblique top three-dimensional view of a second embodiment of a holder or cage for a drinking vessel or water bottle according to the present invention;

FIG. 18 shows a partly exploded oblique bottom three-dimensional view of the holder of FIG. 17;

FIG. 19 shows a bottom view of the holder of FIG. 17, with hidden detail shown in broken lines;

FIG. 20 shows a top view of the holder of FIG. 17, with hidden detail shown in broken lines;

FIGS. 21A and 21B show a top view of the holder of FIG. 17 and an oblique top three-dimensional view of the holder of FIG. 17, in use on a tube of a bicycle frame, respectively, with a cradle of the holder in a centre position;

FIGS. 22A and 22B show a top view of the holder of FIG. 17 and an oblique top three-dimensional view of the holder of FIG. 17, in use on a tube of a bicycle frame, respectively, with a cradle of the holder in a left tilted position;

FIGS. 23A and 23B show a top view of the holder of FIG. 17 and an oblique top three-dimensional view of the holder of FIG. 17, in use on a tube of a bicycle frame, respectively, with a cradle of the holder in a right tilted position; and

FIG. 24 shows an oblique bottom three-dimensional view of an alternative embodiment of a cage of the holder of FIG. 17.

### DETAILED DESCRIPTION OF THE DRAWINGS

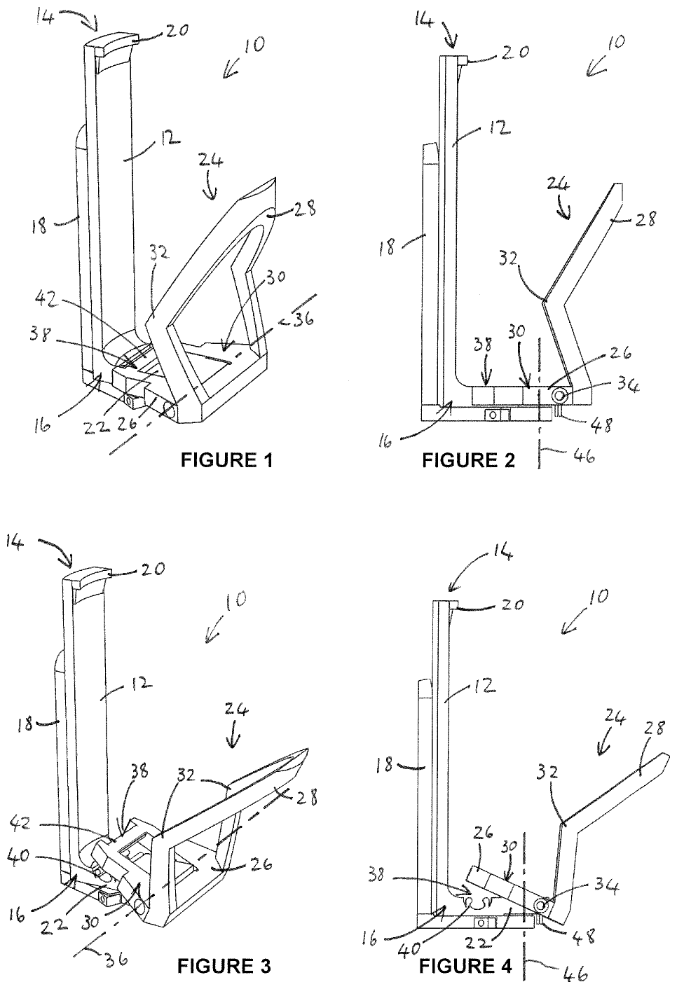

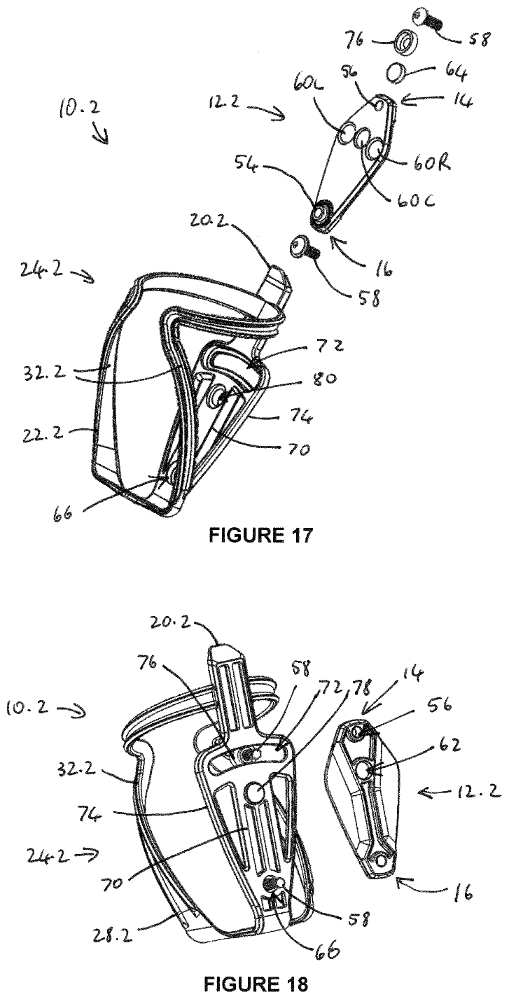

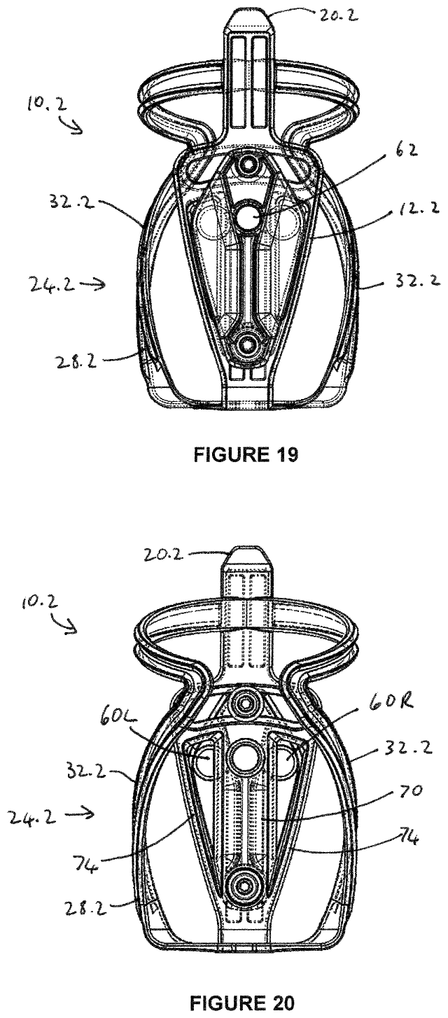

Referring to the drawings, a holder for a drinking vessel such as a water bottle, is generally identified by reference sign 10. The first embodiment of the holder that is shown in FIGS. 1-16 is identified by suffix 1 and the second embodiment of the holder that is shown in FIGS. 17-24 is identified by suffix 2. Similarly, features that share the same name between the two embodiments are distinguished by suffixes referring to the applicable embodiment, where this is desirable for clarity.

Referring to FIGS. 1-4, the holder 10.1 includes a spine 12.1, which is in the illustrated example in the form of a elongate element with a first end or top 14 and an opposite second end or bottom 16, but in other embodiments of the invention, the spine can take various forms, as long as it has two spaced apart ends.

In some embodiments of the invention, the spine 12.1 can be attached directly onto a substrate such as a bicycle frame, but in the illustrated example, the spine is supported on a carrier 18, which is described in more detail below.

At the top 14 of the spine 12.1, a detent 20.1 protrudes transversely from the spine. In the illustrated example, the detent 20.1 is in the form of a lip with a concave edge, but in other embodiments of the invention, the detent can have various other shapes, protruding in the transverse direction.

At the bottom 16 of the spine 12.1, an arm 22 protrudes from the spine, generally in the same transverse direction as the detent 20.1, so that the spine and arm have an overall L-shape and so that the arm and detent are spaced apart by the length of the spine. However, the arm 22 is substantially longer than the detent 20.1 and protrudes much further from the spine 12.1 in the transverse direction.

The holder 10.1 includes a cradle that is generally identified by reference sign 24.1 and the cradle includes a base 26 and a restraining formation, which in the illustrated example is in the form of a frame 28.1. In the illustrated example, the base 26 is generally planar, with a planar top surface 30. In other embodiments, the base 26 could have different overall shapes, but it should define a top surface 30, even if the top surface is not planar and/or has other features. In the illustrated example, the frame 28.1 loops upwards between two corners of the base 26 and the frame is shaped so that it can extend partly around a cylindrical object with two spaced apart, lateral flanks 32.1 extending somewhat around the cylindrical object, towards the spine 12. In other variations of the first embodiment of the invention, the cradle 24.1 (or other restraining formation in lieu of the frame) can take various forms, but it is required that they define a top surface on the base, extend upwards and laterally around a space that is complemental to the bottom of a water bottle, as will be described below.

The cradle 24.1 is pivotally attached to the arm 22 with a first pivot mechanism 34 to pivot about a first pivot axis 36 relative to the arm and spine 12.1 between a closed position shown in FIGS. 1 and 2 and an open position shown in FIGS. 3 and 4. When the cradle 24.1 is in the closed position, it is locked in position by a releasable lock mechanism that is generally identified by reference sign 38. In the illustrated example, the lock mechanism 38 comprises a female clip formation 40 defined in the top of the arm 22 and a bar 42 defined in the base 26 of the cradle 24. The bar 42 has a complemental shape to the clip formation 40 and can be held firmly in the clip formation, or released by hand against a clipping action.

When the lock mechanism 38 is engaged, i.e. the bar 42 is clipped into the clip formation 40, the cradle 24 is held firmly in its lock position by the lock mechanism. In the illustrated example in FIGS. 1-16, this means that the top surface 30 is generally perpendicular to the spine 12.1 and the base 26 is generally aligned with the arm 22. When the lock mechanism 38 is released, the cradle 24.1 is free to pivot about the axis 36 to an open position in which the base 26 is lifted above the arm 22 and faces away from the spine 12.1 and the frame 28 is spaced farther from the spine. The pivotal movement of the cradle 24.1 is preferably limited by stop formations (not shown).

The holder 10.1 is intended for use with a drinking vessel such as a water bottle with some predetermined dimensions. No water bottle is shown in FIGS. 1-4, but water bottles are shown in other figures and are identified generally by reference sign 44 in those figures. The water bottle has a bottom part that is cylindrical with a predetermined radius (which in the current conventions of cycling, is 73 mm) and the bottom, cylindrical part has a predetermined height (of 127 mm in current conventions) between the bottom of the water bottle and an indentation—which is typically in the form of a circumferential recess, but could take other forms of reduction in the radius of the water bottle. These water bottles have been standardised to fit into conventional water bottle cages, which frequently have detents that engage the indentations to prevent the bottles from sliding out of the cages.

Like conventional water bottle cages, the holder 10.1 is shaped and dimensioned to be complemental to a standard water bottle (although other embodiments of the invention could be shaped and dimensioned to suit different drinking vessels). In particular, the spine 12.1 and frame 28.1 are spaced apart so that the cylindrical bottom part of a water bottle can fit snugly between them when the cradle 24.1 is in the closed position, with the spine and cradle engaging opposing sides of the cylindrical shape. Similarly, the top surface 30 of the base 26, and the detent 20.1 are spaced apart so that the bottom part of the water bottle fits snugly between them when the cradle 24 is in the locked position, with the bottom of the water bottle resting on the base and the detent engaging with the indentation of the water bottle.

More particular to the first embodiment of the present invention, the first pivot axis 36 is spaced from the spine 12 by a distance that is greater than the radius of the bottom part of the water bottle, i.e. by more than 36.5 mm for the current standard of water bottles. In the illustrated example in FIGS. 1-16, the first pivot axis 36 is disposed generally at the remote ends of the arm 22 and base 26 (remote from the spine 12.1) and this is preferable, although not essential. The spacing of the first pivot axis 36 away from the spine 12.1 has the effect that the centre of gravity of the water bottle is closer to the spine than the pivot axis 36, so that the weight of the water bottle, exerted on the base 26 causes the cradle 24 to pivot towards the closed position. The holder 10 can be used in different orientations, which will affect the position of the centre of gravity, relative to the first pivot axis 36, but as a rule, the axis of the spine 12 will be generally upright and the farther the pivot axis 36 is from the spine, the more stable the cradle 24 will be in the closed position.

In the illustrated example in FIGS. 1-16, the spine 12.1, arm 22 and cradle 24.1 (and thus all the parts of the holder 10.1 described above, apart from the carrier 18) can pivot relative to the carrier 18 about a second or upright pivot axis 46. This pivotal movement is preferably controlled by a restraint such as a clip 48, but it can instead by controlled with friction, locking elements, fasteners, or the like. The purpose of the rotation about the upright axis 46 is to position the spine 12.1 and cradle 24.1 so that they cooperate as described above, but so that the pivotal movement of the cradle (about axis 36) is angled relative to the attachment to the substrate (i.e. the bicycle frame). This would be required, for example, if a user would find it more comfortable to retrieve and replace water bottles at an angle, e.g. sideways, relative to the bicycle frame.

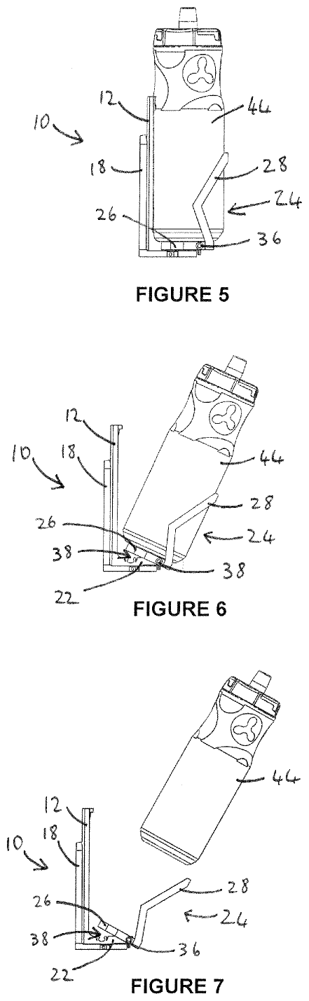

Referring to FIGS. 5 to 7, when a water bottle 44 is received in the holder 10.1 with the cradle 24.1 in its closed position as shown in FIG. 5, the water bottle is held captive by the snug fit of its cylindrical shape between the frame 28.1 and the spine 12.1 and this prevents the water bottle from falling out of the holder sideways. At the same time, the detent 20.1 also grips the water bottle at the indentation to prevent the water bottle from sliding upwards, out of the cradle 24. These operations for retaining the water bottle 44 in the holder 10.1 resemble those of conventional water bottle cages, except that in the present invention, the cradle 24.1 is held in position relative to the arm 22 (and thus also the spine 12.1 and detent 20.1) by operation of the lock mechanism 38 and the weight of the water bottle pressing down on the base 26 of the cradle.

When a user wants to retrieve the water bottle 44 from the holder 10.1, he tilts the water bottle away from the spine12.1, so that the water bottle and cradle 24 pivot together about the first pivot axis 36, as shown in FIG. 6. For this pivotal movement to take place, the lock mechanism 38 first needs to be released, but the resistance of the clipping action in the lock mechanism is designed so that the resistance feels secure, but comfortable to the user. The tilting action of the water bottle 44 and cradle 24.1 causes the detent 20.1 to disengage from the indentation on the water bottle 44 and causes the spine 12.1 to be spaced away from the water bottle, so that the water bottle can easily be moved out of the holder 10, as shown in FIG. 7.

To place the water bottle 44 in the holder 10.1, these steps are reversed. The water bottle is placed in the cradle 24.1 with its bottom resting against the base 26 and the water bottle and cradle are tilted towards the spine 12 until the lock mechanism 38 clips into locking engagement. The user has to press the water bottle 44 against the base 26 to achieve the engagement of the lock mechanism 38, but this pressing action is aided by the weight of the water bottle and is intuitive to the user. The clicking operation of the lock mechanism 38 also provides tactile feedback to the user.

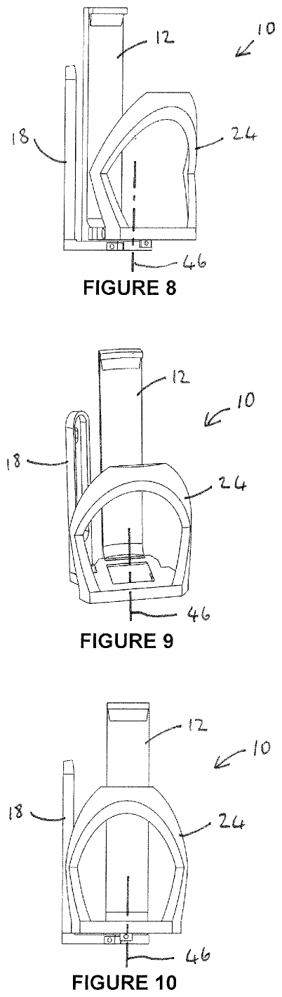

Referring to FIGS. 8 to 10, the holder 10.1 is shown with the spine 12.1 and cradle 24.1 rotated about the upright pivot axis 46, relative to the carrier 18. In FIGS. 8 and 9, the spine 12.1 and cradle 24.1 have been rotated through an acute angle to an oblique position and in FIG. 10, they have been rotated through a right angle, to a side-entry position—to some extent resembling a conventional side-entry bottle cage.

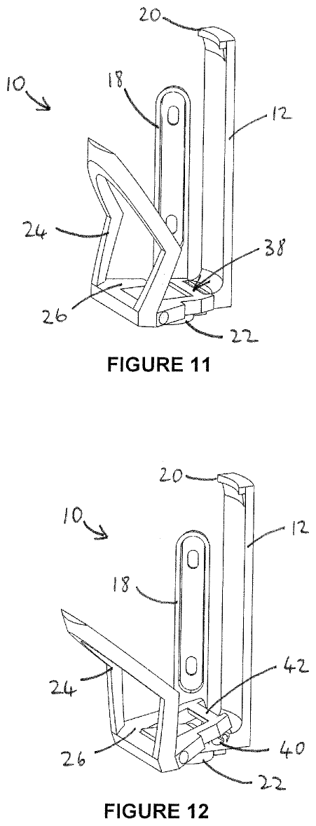

Referring to FIGS. 11 and 12, the holder 10.1 is shown rotated to the same oblique position as shown in FIGS. 8 and 9, but in FIG. 11, the cradle 24.1 is in its closed position, with the lock mechanism 38 engaged, so that a water bottle (not shown) can be held securely between the cradle 24.1 and spine 12.1, as described above. In FIG. 12, the holder is shown in the same position, except that the cradle 24.1 has been pivoted to its open position by unclipping of the bar 42 from the clip 40, so that a water bottle 44 can be retrieved from the cradle, or placed in the cradle.

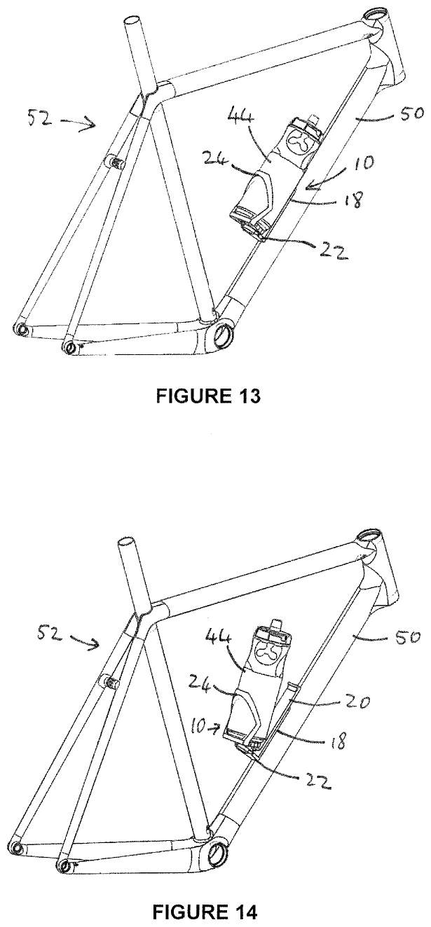

Referring to FIGS. 13 to 16, the holder 10.1 is shown in use with a water bottle 44 and the carrier 18 has been attached to a substrate in the form of a down tube 50 of a bicycle frame 52. In FIGS. 13 and 14, the spine 12.1 is adjacent to the carrier 18 and the cradle 24.1 is shown in FIG. 13 in its closed position, with the water bottle 44 held securely. In FIG. 14, the cradle 24.1 and water bottle 44 have been tilted to the open position, by pivoting the cradle away from the down tube 50, i.e. rearwards relative to the bicycle frame 52, to allow retrieval or placement of the bottle 44 in the holder 10.1.

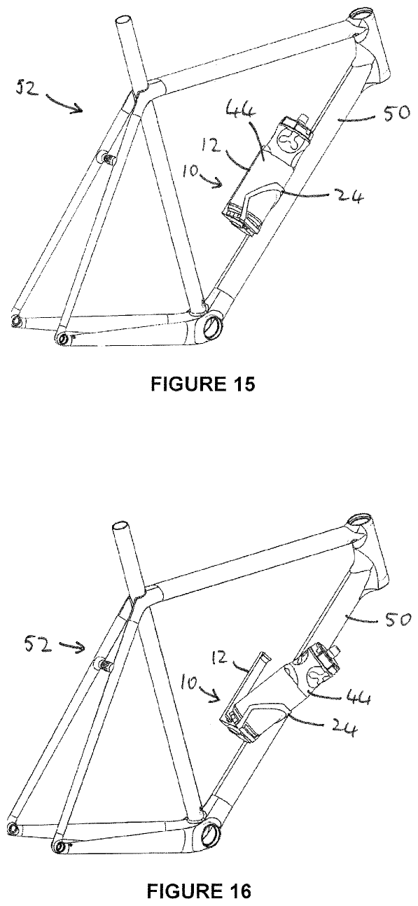

In FIGS. 15 and 16, the spine 12.1 and holder 24.1 have been rotated about the upright pivot axis to a side-entry position. The cradle 24.1 is shown in FIG. 15 in its closed position, with the water bottle 44 held securely and in FIG. 16, the cradle and water bottle have been tilted to the open position, by pivoting the cradle sideways, to the right of the bicycle frame 52, to allow retrieval or placement of the bottle 44 in the holder 10.

Referring to FIGS. 17-23B, in the second illustrated embodiment of a carrier 10.2 according to the invention, also includes a spine 12.2, which is firmly attachable to a substrate such as a down tube 50 of a bicycle frame. The spine 12.2 is a generally plate-like body with a hollow truncated boss 54 protruding near a bottom 16 of the spine. At the top 14 of the spine 12.2, a hole 56 is defined in the spine and the spine can be attached to a substrate such as a bicycle downtube 50 (or any other substrate, as reasonably required), by passing two screws 58 through the hole 56 and the hollow centre of the boss 54, respectively.

On a front of the spine 12.2, three shallow recesses 60 are defined, comprising a left recess 60L, a centre recess 60C and a right recess 60R. On the back of the spine 12.2, a spine magnet recess 62 is defined, in line with the centre recess 60C, but with a thin wall of the material of the spine extending between the recesses 60C and 62. A centre magnet 64 is received inside the spine magnet recess 62 and thus exerts a magnetic field in the immediately adjacent centre recess 60C.

The holder 10.2 also includes a cradle 24.2, which is shaped and configured to grip the bottom part of a water bottle, by means of a frame 28.2 which forms two flanks 32.2. However, unlike the cradle shown in the first embodiment of the invention in FIGS. 1-16, the cradle 24.2 includes a detent 20.2, which supplements the frame 28.2 in holding the water bottle firmly within the cradle 24.2.

The cradle 24.2 defines a bottom aperture 66 that has a circumference that fits over the boss 54 with sufficient clearance to enable the cradle to slide pivotally about the boss. The cradle 24.2 is held pivotally attached to the spine 12.2 by one of the screws 58—preferably with a washer or in the form of a washer head screw. The attachment of the cradle 24.2 to the spine 12.2 by means of the screw 58, passed through the bottom aperture 66 and the boss 54 (and into the down tube 50, or other substrate), forms a pivot mechanism 68, which is shown in the drawings, with reference to the pivot axis of the pivot mechanism. The pivot mechanism 68 allows the cradle 24.2 to pivot about the axis of the pivot mechanism between a centre position and tilted positions—as will be described in more detail below.

The cradle 24.2 can take many shapes, but in the illustrated embodiment, it includes a central beam 70 that extends between the bottom aperture 66 and the detent 20.2. A curved guide slot 72 is defined in the cradle 24.2 and extends across the beam 70. The slot 72 curves about the axis of the pivot mechanism 68 at a radius generally equal to a distance between the boss 54 and screw hole 56—a radius that is thus equal to the spacing between the screws 58. In the illustrated embodiment, the cradle 24.2 includes two braces 74 that extend from ends of the slot 72 to the vicinity of the bottom aperture 66, to lend structural stability to the cradle.

A bush 76 extends around the head of the screw 58 that passes through the screw hole 56 at the top 14 of the spine 12.2 and the bush is receivable in the slot 72 with sufficient clearance to allow the bush to slide along the slot when the cradle 24.2 pivots about the axis pivot mechanism 68. The slot 72 defines a shoulder about its periphery, preventing the bush 76 from withdrawing through the slot, so that the screw 58 and bush serve as a pin that is stationary relative to the spine 12.2 and substrate or down tube 50, and the pin guides pivotal movement of the cradle 24.2, while sliding along the slot 72.

On the underside of the beam 70, there is a protuberance 78 that has a shape and dimensions that are generally complemental to the recesses 60 on the spine 12.2. On the top of the beam 70, directly opposite from the protuberance 78, there is a cradle magnet recess 80. A cradle magnet is received in the cradle magnet recess 80, but is not shown in the drawings. However, for the sake of brevity, reference will be made herein to the cradle magnet, by reference sign 80—even though reference sign 80 refers in the drawings, to the recess in which the cradle magnet is received. The cradle magnet 80 exerts a magnetic field about the immediately adjacent protuberance 78.

The cradle magnet 80 and the centre magnet 64 are magnetically attracted to each other, when the cradle is in its centre position and the cradle magnet and centre magnet are generally in alignment. In other embodiments of the invention, either one of the cradle magnet 80 or the centre magnet 64 could be replaced with a ferrous metal, or other element that is magnetically attracted. In yet further embodiments of the invention, there could be more magnets and/or the magnets could be positioned differently, as long as the magnets (or other magnetic elements) on the cradle 24.2 are magnetically attracted by their counterparts on the spine 12.2.

The attraction between the cradle magnet 80 and the centre magnet 64 serves as a retention mechanism that retains the cradle in its centre position, against pivotal movement about the axis of the pivot mechanism 68. However, if the attraction between these magnets 80,64 is overcome, e.g. by manual pivoting of the cradle 24.2 relative to the spine 12.2, to a tilted position, then the magnets are farther apart and the attraction between them is too weak to pivot the cradle back to the centre position. Once the cradle 24.2 is returned to the centre position, the magnetic attraction between the magnets 80,64 resumes and the cradle is again retained in its centre position, against pivotal movement.

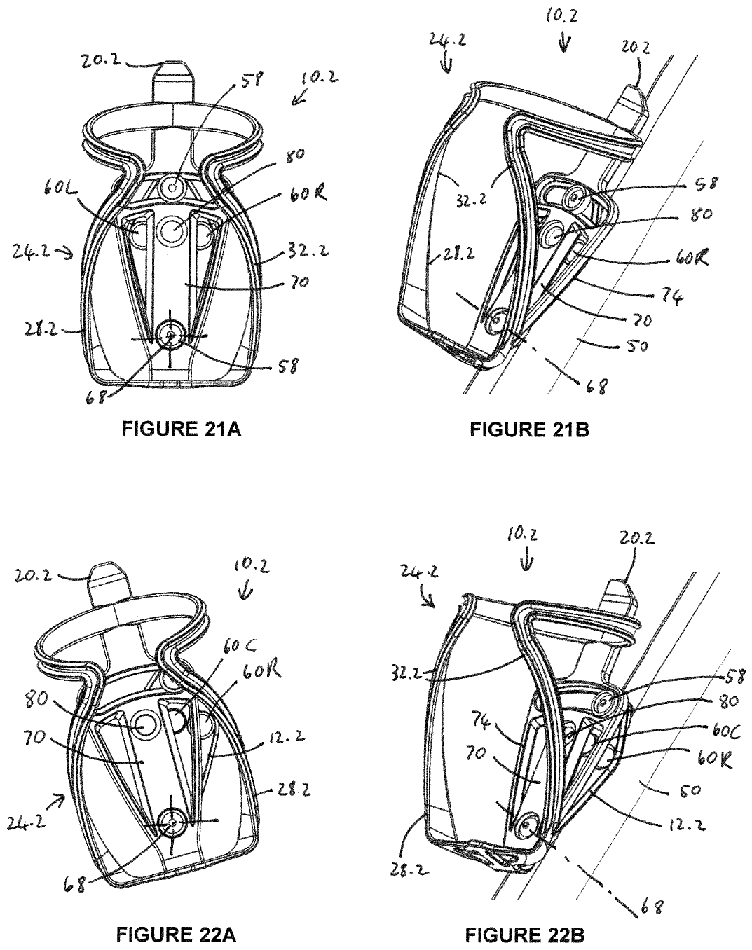

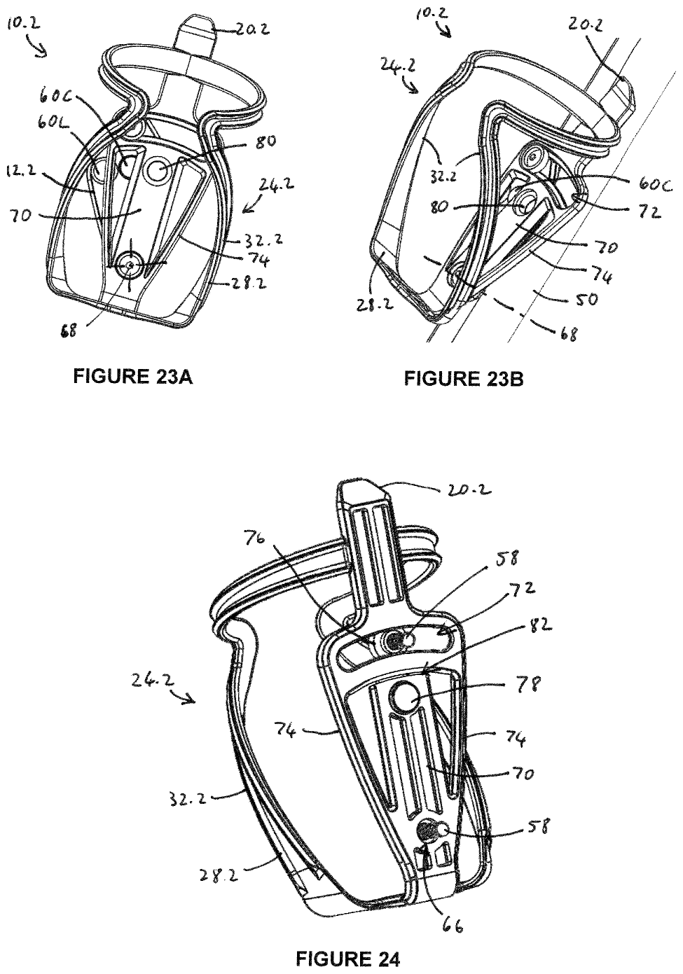

In the illustrated embodiment of the invention, the cradle 24.2 is shown: in its centre position in FIGS. 21A and 21B; in a left tilted position in FIGS. 22A and 22B, with the protuberance 78 and cradle magnet 80 aligned with the left recess 60L on the spine 12.2; and in a right tilted position in FIGS. 23A and 23B, with the protuberance 78 and cradle magnet 80 aligned with the right recess 60R on the spine 12.2. In other embodiments of the invention, more magnets could be provided in the spine 12.2, that are aligned with the left and right recesses 60L,60R, respectively, which would attract the cradle magnet 80 when the cradle 24.2 is pivoted to the left tilted position or the right tilted position. Similarly, in other embodiments of the invention, more magnets may be provided on the cradle 24.2 laterally of the cradle magnet 80, so that either of the lateral magnets is aligned with the centre magnet 64 when the cradle is tilted, to hold the cradle in its tilted position. In further embodiments of the invention, other numbers or magnets and/or magnetically attracted elements could be used.

The spine 12.2 and cradle 24.2 are preferably made of a tough, durable, resilient material that is not attracted by magnetism and there are a variety of suitable polymers that would serve this purpose. The tough resilience of the material is required for durability of the holder 10.2 and to hold a water bottle in the cradle 24.2, but also because the cradle 24.4 and spine 12.2 are shaped and dimensioned such that the protuberance 78 on the beam 70 of the cradle, is receivable in each of the recesses 60 on the spine 12.2 with a clip action engagement. When the protuberance 78 is received in the centre recess 60C, the engagement of the protuberance in the centre recess serves as a mechanical lock, to retain the cradle 24.2 in its centre position and to hold it against pivoting action, until the engagement of the protuberance in the centre recess is overcome by manually pivoting the cradle from its centre position to either of its tilted positions. Similarly, engagement of the protuberance 78 in either of the other two recesses 60L and 60R serves as a mechanical lock to retain the cradle 24.2 against pivotal movement.

Referring to FIG. 24, in a preferred variation of the second embodiment of the holder 10.2, the beam 70 may be connected to the rest of the cradle 24.2 only in the vicinity of the bottom aperture 66 and extend in a flexible cantilever configuration to the position where the protuberance 78 is formed, while the beam is separated by a slot 82 from the rest of the cradle. This configuration allows the beam 70 to flex more easily relative to the rest of the cradle 24.2 and thus allows the protuberance 78 to move towards and away from the spine 12.2 as the beam flexes. This movement of the protuberance 78, with a bias towards the spine 12.2 provided by the resilience of the beam 70 allows the protuberance to act as a movable catch that can clip into one of the recess 60, when it is aligned with that recess—i.e. when the cradle 24.2 is in its centre position or either of its tilted positions.

The clipping action of the protuberance 78 into the recesses 60 is enhanced in a synergistic manner by the magnetic attraction between the cradle magnet 80 and the centre magnet 64, which assists the bias provided by the resilience of the beam 70, in urging the protuberance 78 into clipping engagement inside the centre recess 60C.

Referring to FIGS. 17-24: in use, a user places a water bottle in the cradle 24.2 in the conventional manner and the water bottle is retained in the cradle by interaction of the geometries and resilience of the bottle, the frame 28.2 and the detent 20.2. The water bottle remains in place and the cradle 24.2 is held in its centre position by engagement of the protuberance 78 in the centre recess 60C and magnetic attraction of the cradle magnet 80 and the centre magnet 64—as described above.

When the user wants to retrieve the water bottle from the holder 10.2, he grips the upper part of the water bottle that protrudes farthest from the cradle 24.2 and lightly pulls it sideways to overcome the mechanical and magnetic retention mechanisms and pivot the cradle 24.4 to the left or right tilted position, as desired. The strength of the magnets 80,64 and the geometry of the complementary protuberance 78 and recess 60 are selected such that the sideways pulling action required by the user is easy, but provides tactile feedback—and so that the combined effectiveness of these retention mechanisms can keep the cradle 24.2 in its centre position until the user pivots it to a tilted position.

When the cradle 24.2 is in a left or right tilted position, the water bottle can be withdrawn easily to the side of the bicycle and after the water bottle has been used, it can be returned and the cradle 24.2 pivoted back to its centre position, by reversing the actions described above—and requiring very little effort from the user.

1. A holder for a drinking vessel, a bottom part of said drinking vessel having predetermined dimensions, said holder comprising:
a spine that is fixedly attachable to a substrate;
a cradle that is shaped and dimensioned to receive the bottom part of the drinking vessel and to retain the bottom part of the drinking vessel in the cradle;
a pivot mechanism extending between the cradle and the spine, said pivot mechanism being configured to allow the cradle to pivot relative to the spine about a pivot axis of the pivot mechanism, between a centre position and at least one tilted position; and
a retention mechanism that is disposed to retain the cradle in the centre position when the retention mechanism is engaged, and to allow the cradle to pivot to the tilted position when the retention mechanism is disengaged.

2. The holder for a drinking vessel according to claim 1, wherein the retention mechanism includes at least one centre magnetic element that is disposed on the spine, and at least one cradle magnetic element that is disposed on the cradle, said centre magnetic element and said cradle magnetic element being in close proximity to each other and being magnetically attracted to each other when the retention mechanism is engaged.

3. The holder for a drinking vessel according to claim 2, wherein the retention mechanism includes a mechanical lock that is configured to hold the cradle against pivotal movement relative to the spine, when the retention mechanism is engaged.

4. The holder for a drinking vessel according to claim 3, wherein the mechanical lock includes a centre receiving formation defined on the spine in proximity to the centre magnetic element, and a movable catch that forms part of the cradle and that can engage the receiving formation to engage the mechanical lock retention mechanism, said cradle magnetic element being disposed on the catch such that magnetic attraction between the centre magnetic element and the cradle magnetic element causes the catch and cradle magnetic element to move towards the receiving formation and engage the receiving formation.

5. The holder for a drinking vessel according to claim 1, wherein the pivot mechanism is configured to allow the cradle to pivot about the pivot axis, between a centre position and two tilted positions, said two tilted positions being disposed on opposing sides of the centre position.

6. The holder for a drinking vessel according to claim 1, which includes at least one lateral magnet, said lateral magnet being disposed to be attracted to either the centre magnetic element or the cradle magnetic element, when the cradle is in the tilted position.

7. The holder for a drinking vessel according to claim 2, wherein the pivot mechanism is configured to allow the cradle to pivot about the pivot axis, between a centre position and two tilted positions, said two tilted positions being disposed on opposing sides of the centre position.

8. The holder for a drinking vessel according to claim 3, wherein the pivot mechanism is configured to allow the cradle to pivot about the pivot axis, between a centre position and two tilted positions, said two tilted positions being disposed on opposing sides of the centre position.

9. The holder for a drinking vessel according to claim 4, wherein the pivot mechanism is configured to allow the cradle to pivot about the pivot axis, between a centre position and two tilted positions, said two tilted positions being disposed on opposing sides of the centre position.

10. The holder for a drinking vessel according to claim 2, which includes at least one lateral magnet, said lateral magnet being disposed to be attracted to either the centre magnetic element or the cradle magnetic element, when the cradle is in the tilted position.

11. The holder for a drinking vessel according to claim 3, which includes at least one lateral magnet, said lateral magnet being disposed to be attracted to either the centre magnetic element or the cradle magnetic element, when the cradle is in the tilted position.

12. The holder for a drinking vessel according to claim 4, which includes at least one lateral magnet, said lateral magnet being disposed to be attracted to either the centre magnetic element or the cradle magnetic element, when the cradle is in the tilted position.

13. The holder for a drinking vessel according to claim 5, which includes at least one lateral magnet, said lateral magnet being disposed to be attracted to either the centre magnetic element or the cradle magnetic element, when the cradle is in the tilted position.
